(19) United States
(12) Patent Application Publication
(10) Pub. No.: US 2024/0177614 A1
(43) Pub. Date: May 30, 2024

(54) IN-FLIGHT WEATHER SENSOR DATA PROCESSING AND TRANSMISSION BETWEEN AIRCRAFT

(71) Applicant: INTERNATIONAL BUSINESS MACHINES CORPORATION, Armonk, NY (US)

(72) Inventors: Christopher Muzzy, Burlington, VT (US); Noah Singer, White Plains, NY (US); Madhana Sunder, Meridian, ID (US)

(21) Appl. No.: 18/071,984

(22) Filed: Nov. 30, 2022

(51) Int. Cl. G08G 5/00; G06N 3/04; G07C 5/00; G07C 5/08; G08G 5/04

(52) U.S. Cl. CPC G08G 5/0021; G06N 3/04; G07C 5/008; G07C 5/0808; G07C 5/0825; G08G 5/0008; G08G 5/006; G08G 5/0091; G08G 5/045

(57) ABSTRACT

A computer-implemented method operating on a first aircraft and performed by one or more processors collects sensor data and aircraft performance data generated by the first aircraft during flight. The method pre-processes the sensor and performance data generating a context with respect to the first aircraft. The method transmits the pre-processed sensor data and first aircraft performance data to a set of aircraft within a region of the first aircraft. The method receives pre-processed sensor data and aircraft performance data from the set of aircraft within the region of the first aircraft. The method processes the received pre-processed sensor and performance data from the set of aircraft, and the method generates alerts associated with adverse conditions determined based on the analysis of the pre-processed sensor data and performance data received from the set of aircraft in the context of the performance data of the first aircraft.

### BACKGROUND

The present invention relates to the processing of weather sensor data and, more specifically, processing weather data locally on an airborne aircraft and transmitting the processed data to other aircraft within a defined vicinity.

Weather conditions can have a significant impact on aircraft performance and safety and can often result in flight delays, re-routing, and cancelations. Additionally, weather conditions can affect aircraft performance and safety during flight, particularly during takeoffs and landings. Snow and ice conditions may require additional services to be performed on aircraft prior to takeoff (i.e., deicing procedures). Ground-based sensors and measurement devices provide a predominant portion of weather data, serving as input to weather analysis and forecasting models to identify and predict weather conditions. In some cases, weather measurements taken from an aircraft during a flight are included as input to ground-based weather models.

Pulsed light detection and ranging (LIDAR) techniques have been used to measure airflow velocity, direction, and turbulence, however, high levels of particles in the air prevent accurate measurements from upper elevations. Ground-based analysis and forecasting models often receive collected weather data as input, however, the receipt of weather data transmitted from aircraft does not occur during flight. Ground-based models process the weather data and can provide weather condition information to aircraft, often through air traffic control (ATC) transmissions.

### SUMMARY

According to one embodiment of the present invention, a computer-implemented method provides for provisioning available non-critical resources of autonomous vehicles.

Aspects of the invention disclose a computer-implemented method, system, and computer-readable media associated with providing a local transmission of aircraft sensor data and performance data between airborne aircraft, the method includes one or more processors of the first aircraft collecting weather sensor data and aircraft performance data during flight. The one or more processors of the first aircraft pre-process the weather sensor data and performance data generating a context of the weather sensor data. The one or more processors of the first aircraft transmit the pre-processed weather sensor data and first aircraft performance data to a set of aircraft within a region in the vicinity of the first aircraft. The one or more processors of the first aircraft receives the pre-processed weather sensor data and aircraft performance data from aircraft of the set of other aircraft within the region in the vicinity of the first aircraft. The one or more processors of the first aircraft process the received pre-processed weather sensor data and performance data from the aircraft of the set of aircraft within the region in the vicinity of the first aircraft, and the one or more processors of the first aircraft generate alerts associated with adverse conditions detected based on analysis of the pre-processed sensor data and performance data received from the aircraft of the set of aircraft.

### BRIEF DESCRIPTION OF THE DRAWINGS

FIG. 1 provides a schematic representation of a computing environment, in accordance with an embodiment of the present invention.

FIG. 2 depicts an exemplary in-flight local data transmission scenario, in accordance with an embodiment of the present invention.

FIG. 3 provides a flowchart of operational steps for a local aircraft weather program, in accordance with an embodiment of the present invention.

### DETAILED DESCRIPTION

Some embodiments will be described in more detail with reference to the accompanying drawings, however, embodiments of the present disclosure can be implemented in various manners, and thus should not be construed to be limited to the embodiments disclosed herein.

Weather data from aircraft sensors can improve the accuracy and effectiveness of weather condition analysis, processing, and forecast, however, most weather models don't receive adequate weather data from in-flight aircraft, and most aircraft experience significant lag time in receiving weather condition information and advisory from ground-based weather models operating on weather servers. The large lag time between the download of data to ground-based weather modeling, processing of the data by the model, and upload transmission of processed results to other aircraft in flight can render the information useless, and dynamic conditions may not be determined and reported in time to avoid or prepare. Situations in which adverse weather conditions develop suddenly during aircraft takeoff and landings can expose aircraft to potentially damaging or disastrous results.

Embodiments of the present invention recognize that weather conditions affect aircraft performance, quality of service, and safety. Weather conditions affecting aircraft may include but are not limited to convective activity, wind speed and direction, wake turbulence, precipitation, microbursts, wind shear, air pressure zones, and temperature gradients, all of which are difficult to measure at altitude from ground-based sensors and detectors. Additionally, aircraft-based cameras and/or radar can detect the presence of birds in flight (i.e., non-weather conditions, but transmitted data and local processing may enable avoidance), which presents a significant threat to engine failure and other aircraft damage.

Embodiments of the present invention recognize that air traffic volume and density have increased over time, and airports, particularly those in or near metropolitan areas, practice short time intervals between aircraft for takeoffs and landings. Embodiments recognize that adverse weather conditions experienced by one aircraft in a path shared by follow-on aircraft can provide valuable advance notice to the nearby aircraft following the same path, such as in an approach to landing. Similarly, extreme turbulence encountered during flight may extend vertically or horizontally from the affected aircraft. Rapid transmission of weather condition data along with the performance data of the affected aircraft to other aircraft in the vicinity of the turbulence, and local processing of the data by the other aircraft, may allow the other aircraft to take actions to avoid or mitigate the impact, and warn passengers to prepare, if unavoidable. The transmission of the performance data of the affected aircraft provides a context in which the weather data from sensors can be processed and enables the other aircraft receiving the data to determine whether and to what extent the weather condition data may affect the other aircraft. Transmission of the weather and performance data obtained by the affected aircraft to the other aircraft in the vicinity for local processing avoids significant lag time and provides additional time for the receiving aircraft to take proactive actions. Furthermore, the affected aircraft also receives weather and performance data from the other aircraft, which may contribute additional data of interest or concern for the affected aircraft.

An aspect of the present invention includes the generation of raw data from sensors aboard the in-flight aircraft and performance data associated with the particular aircraft, which may include air speed, direction, altitude, GPS position, aircraft type, cargo, and aircraft weight.

Another aspect of the present invention includes a step in the data mining and analysis process of performing pre-processing on sensor data. Each respective raw data type can assume a different or unique form or format. Pre-processing refers to transitioning the raw data gathered by the aircraft into a standard, usable format that can be understood and analyzed by computers and machine learning models. The onboard computing resource algorithms pre-process the raw data prior to transmitting the data to other aircraft. Different aircraft manufacturers use different firmware and data structures in the flight management system (FMS, inclusive of flight software on board an aircraft), so the format of the data needs to be standardized.

As an example, some sensors may generate voltage or current levels corresponding to the physical entity being measured, such as wind speed, temperature, and air pressure, whereas wind direction sensors or LIDAR measurements may generate raw data of particulate position change and distance between laser pulses. Additionally, one aircraft may report ambient pressure (i.e., data associated with altitude, aircraft speed, etc.) in KPa and another may report it in PSI. The data may also be written to different variable terms, such as “AMB” vs. “AMP”, so the pre-processing converts all raw data to standard variables and units, resulting in consistent, usable information before transmission of the data to the other nearby aircraft. In the current state of the art, aircraft data collection does not include pre-processing, because the data remains with the data-collecting aircraft.

Post-processing takes the received pre-processed/standardized data and applies it in the context of the receiving aircraft to make it useful. The factors that affect the post-processing of the data include the aircraft's flight path, aircraft type, fuel, crew, weight, and subsystem status. For example, if a large aircraft (e.g., Boeing 747-340,000 lbs.) receives the pre-processed data on wind shear, which caused a minor altitude change to a small aircraft (e.g., Cessna 172-2,500 lbs.), then the post-processed data for the larger aircraft may not consider the received data as an adverse condition, because the larger aircraft wouldn't be affected. In the converse situation in which a smaller aircraft receives the same pre-processed data from a larger aircraft, the crew of the smaller aircraft, subsequent to post-processing, would receive alerts from methods of the present invention as a flight safety issue. Embodiments include other aircraft performing post-processing of received pre-processed data resulting in applying the processed and analyzed data in the context of the respective receiving aircraft. Method outputs may include options of actions to take, all of which are in a format understood by the aircraft crew. In some embodiments, the options provide recommendations presented to the crew via the FMS interface for handling any predicted weather issues such as turbulence. Aspects of the invention include machine learning/AI models generating a ranked listing of options that take into consideration the incoming data and the respective aircraft-specific factors (i.e., performance data of data-receiving aircraft).

Aspects of the present invention generally relate to the direct transmission of pre-processed weather sensor data and performance data gathered from an in-flight aircraft and transmitted to other aircraft within a vicinity in which the other aircraft may encounter adverse weather conditions associated with the transmitted data. Disclosed methods include collecting sensor data and operational data from a first aircraft during flight. The collected data includes weather-based data generated from sensors onboard the aircraft, data associated with the aircraft, the aircraft's position, and the aircraft's direction of travel, and may also include data associated with the flight path of the aircraft, such as detecting birds in flight. Disclosed methods include performing pre-processing of the collected sensor data to standardize the data into a useful and consistent format. Disclosed methods transmit the pre-processed data to other aircraft in a pre-determined vicinity of the data-collecting first aircraft. The transmission of the pre-processed data includes the operational/performance data of the first aircraft, enabling receiving aircraft to apply the received sensor data in the context of the parameters associated with the first aircraft.

Disclosed methods include receipt of sensor data and operational/performance data from the other aircraft by the first aircraft. Methods of the present invention, operating in the other aircraft within a pre-determined vicinity of the first aircraft also collect, pre-process, and transmit local sensor and aircraft performance data to each other and the first aircraft. In addition, the first aircraft maintains a copy of the sensor and performance data transmitted to the other aircraft. By transmission and receipt of in-flight sensor and performance data between aircraft in the pre-determined vicinity, and by performing local analytical processing by machine learning/AI models onboard the aircraft, large delay time of providing ground-based weather advisory and optional actions to in-flight aircraft can be avoided.

Disclosed methods include post-processing of the pre-processed data received from the set of other aircraft. The post-processing includes analysis of the received pre-processed data in the context of the transmitting aircraft parameters and the receiving aircraft parameters (i.e., airspeed, direction, altitude, aircraft type, weight, cargo, etc.). The post-processing includes analysis of the standardized and formatted data received by a weather forecasting model, such as a machine learning algorithmic model, or artificial intelligence model, such as a deep learning artificial neural network (ANN) model. Artificial neural networks have been found to more effectively and accurately model the non-linearity of weather data and forecasts.

Disclosed methods include generating alerts to the first aircraft associated with detected adverse conditions resulting from the processing of the sensor and performance data collected by the first aircraft and the pre-processed data and performance data received from other aircraft in the pre-defined vicinity. Methods include at least one of an aural alert and a displayable alert that includes identifying the adverse condition. Displayed alerts may be presented to the crew on flight management system displays of the aircraft. In some embodiments, the generated alerts include a ranking of options of actions to mitigate the adverse conditions determined by the machine learning/AI model. Methods present the recommended options to the crew of the first aircraft in terms understood and familiar to the crew and the recommended actions consider the received pre-processed data and the specific parameters and factors of the first aircraft. Methods rank the options based on potential effectiveness balanced with risk, considering the current aircraft status (i.e., takeoff, landing, in-flight, etc.), and performance parameters.

Aspects of the invention include the simultaneous transmission of sensor data to a ground-based weather modeling and forecasting service along with the transmission of pre-processed sensor and aircraft performance parameter data to other aircraft in the vicinity. Ground-based weather and forecast modeling benefits and continues to learn and update models based on the continuous input of pre-processed sensor data, aircraft operational/performance data, and feedback regarding actions taken from ranked option lists presented to aircraft crews.

Another aspect of the invention includes providing air traffic control (ATC) with alerts regarding sensor data of hazardous weather conditions while simultaneously transmitting sensor data to other aircraft. Ground-based weather detection has limitations and aircraft sensors are more effective in accurately and expediently measuring and reporting sensor data of weather-based conditions at flight altitudes. Most aircraft-generated weather and performance data are not relayed to ground entities during flight other than manual audio messages to air traffic control (ATC). Inclusion of ATC in data aircraft-based weather sensor transmissions enables possible flight plan changes to avoid identified airspace exhibiting adverse conditions, prior to takeoff or earlier in-flight paths while the aircraft remains outside of sensor data transmission range but scheduled to enter the adverse condition airspace.

In some embodiments of the present invention, methods determine of the vicinity of other aircraft to the first aircraft collecting sensor data based on the limitation of local transmission range. In some embodiments, transmission between airborne aircraft in the local vicinity may be by automatic dependent surveillance-broadcast (ADS-B), which uses GPS satellite signals for transmission, or other aircraft-to-aircraft existing (VHF) or future technologies. In some embodiments, the aircraft-to-aircraft transmission may be by a reserved radio frequency, or in other embodiments, transmission between aircraft may be facilitated by cellular communications.

Another aspect of the present invention includes an onboard weather data-based model receiving incoming pre-processed sensor data from other aircraft in the vicinity and sensor and aircraft performance data from its host aircraft. The onboard model can be a machine learning model, such as an artificial neural network model, trained on historic weather sensor data and input from existing weather modeling and forecasting functions. In some embodiments, the training data includes correction or avoidance actions for the aircraft crew to consider, corresponding to the model analysis of the sensor data. In some embodiments, methods continue to update the model based on receiving additional training datasets from other local processing units.

The solution and improvements provided by the method are not abstract and specifically involve artificial neural network models determining adverse weather conditions (or other adverse conditions such as detecting birds in the flight path). The solution and improvements include pre-processing of sensor data and aircraft operational data, the transmission of pre-processed data to other aircraft within a vicinity (e.g., within a transmission range), locally (i.e., each respective aircraft) post-processing data and the generation of alerts along with ranked options presented to aircraft crew to avoid or mitigate the adverse conditions. The local pre-processing and post-processing are performed by an onboard machine learning model. The solution and improvements cannot be otherwise performed as a mental process performed by a human due to reliance on receiving and standardizing sensor data, determining weather conditions based on sets of pre-processed sensor data, and determining a context of the weather condition with regard to performance parameters of respective aircraft, none of which can reasonably be done as a mental process. Further, the generation of action options to mitigate the determined adverse conditions based on processing sensor data cannot be reasonably performed by the mental processes of a human.

In an embodiment, one or more components of the system can employ hardware and/or software to solve highly technical problems (e.g., applying methods to transmit sensor data collected by a first aircraft to other aircraft, determining local adverse weather conditions in the context of a particular aircraft in flight, and alert and recommend actionable options for aircraft crew). The practice of the methods provides improvement to airline transportation, providing practical application of safety, efficiency, and service quality by providing, and essentially improving the latency, awareness, and notification of weather-based adverse conditions for aircraft, enabling proactive remediating actions by crew members of nearby aircraft.

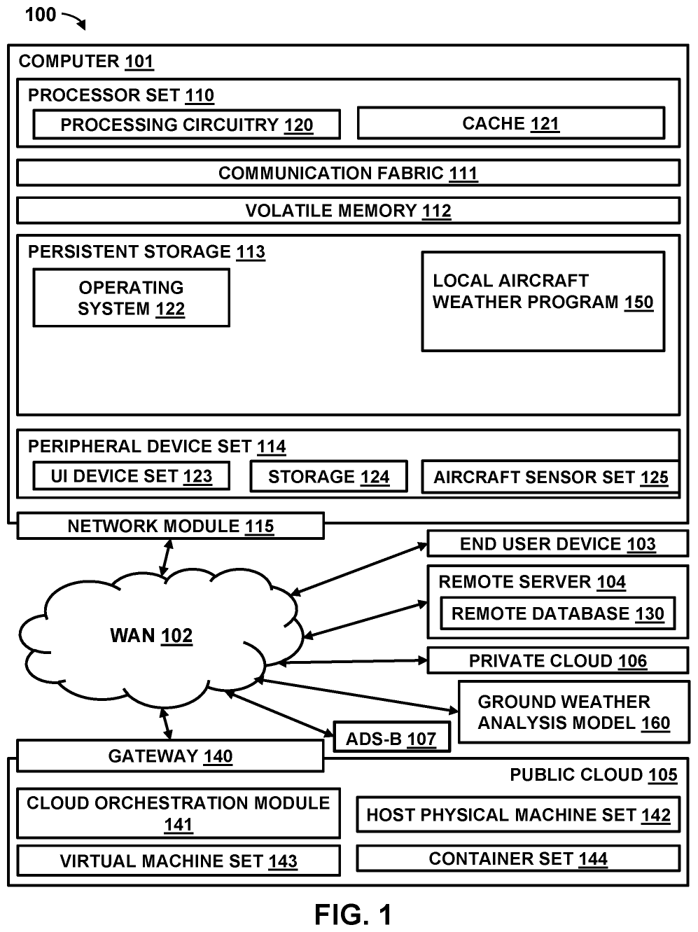

FIG. 1 provides a schematic illustration of exemplary network resources associated with practicing the disclosed inventions. The inventions may be practiced by the disclosed processors performing an instruction stream. As shown in FIG. 1, computing environment 100 contains an example of an environment for the execution of at least some of the computer code involved in performing the inventive methods, such as the method of local aircraft weather program in block 150, retained in persistent storage 113. In addition to block 150, computing environment 100 includes, for example, computer 101, wide area network (WAN) 102, end-user device (EUD) 103, remote server 104, public cloud 105, private cloud 106, and transmission connections to other aircraft and ground-based weather analysis models by automatic dependent surveillance-broadcast (ADS-B) 107. In this embodiment, computer 101 includes processor set 110 (including processing circuitry 120 and cache 121), communication fabric 111, volatile memory 112, persistent storage 113 (including an operating system 122 and a local aircraft weather program of block 150, as identified above), peripheral device set 114 (including user interface (UI), device set 123, storage 124, and aircraft sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or another wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation on computing environment 100, a detailed discussion is focused on a single computer, specifically computer 101, to keep the presentation as simple as possible. Computer 101 may be located onboard an aircraft or located in a cloud environment, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct the performance of the inventive methods. In computing environment 100, at least some of the instructions for performing the inventive methods may be stored as a provisioning available resources program in block 150, in persistent storage 113.

COMMUNICATION FABRIC 111 includes the signal conduction paths that allow the various components of computer 101 to communicate with each other. Typically, this fabric includes switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things (IOT) applications. For example, one sensor may be a thermometer and another sensor may be a motion detector. In an exemplary embodiment, IoT sensor set 125 includes static and dynamic IoT devices providing input data to the GSS model along with historical and online social media-based data.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers. In an exemplary embodiment, WAN 102 enables access to and receipt of data from historical data of safety-related incidents of travel parking spots, which may be stored in a remote database 130. WAN 102 also enables access to and receipt of data from social media sources, blockchain data, and ad-hoc crowd-sourced feedback data, which may be accessed via gateway 140 to public cloud 105, for example.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on. In some embodiments, EUD 103 receives and displays a listing of safety level scores for travel parking spots in the geospatial area of the user's vehicle and one or more recommendations.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

AUTOMATIC DEPENDENT SURVEILLANCE-BROADCAST (ADS-B) SYSTEM 107, is an aircraft system device that uses global positioning system satellite signals to send aircraft information to recipients, such as Air Traffic Controllers and other similarly equipped aircraft. Methods transmit aircraft-collected sensor data and aircraft attribute and performance data, subsequent to pre-processing, to other aircraft within a vicinity of the data-collecting aircraft by utilizing the ADS-B system device. Furthermore, the ADS-B system device transmits pre-processed sensor data to ground-based weather modeling servers, which can be used by the models to improve accuracy and effectiveness.

GROUND-BASED WEATHER ANALYSIS AND FORECAST MODEL 160 receives ground-based sensor and radar data as well as aircraft sensor data transmitted from airborne aircraft. In some embodiments, ground-based weather analysis and forecast model 160 continues to perform machine learning by received data (e.g., aircraft sensor data and feedback on recommendations taken by aircraft crew) and improve weather analysis and forecast modeling. In some embodiments, ground-based weather analysis and forecast model 160 provides updates to onboard weather models of aircraft.

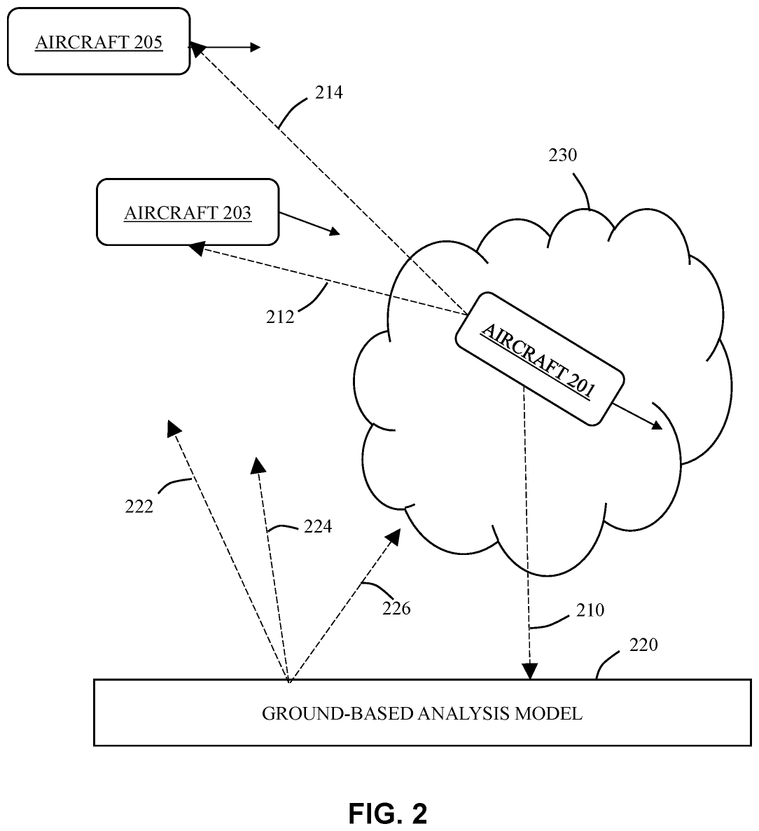

FIG. 2 (FIG. 2) depicts an exemplary in-flight local data transmission scenario, in accordance with an embodiment of the present invention. FIG. 2 includes aircraft 201, aircraft 203, and aircraft 205. FIG. 2 depicts aircraft 201 as positioned within adverse condition zone 230, which has been determined based on onboard atmospheric and other sensors, as well as data of aircraft performance, such as unanticipated airspeed changes, direction changes, altitude changes, air pressure changes, wind speed and direction measurements, aircraft turbulence experienced, etc. The depiction of aircraft 201 includes an indication (solid arrow) of a travel direction of aircraft 201.

FIG. 2 depicts aircraft 203 and aircraft 205 as trailing aircraft 201 by different relative distances and includes indications (respective solid arrows) of the instant travel directions of each aircraft. Aircraft 201, 203, and 205 include instances of methods of the present invention operating on the respective aircraft. In an embodiment of the present invention, aircraft 201, 203, and 205 are all in or beginning an approach for landing, and plan to follow a similar landing glide slope to the airport runway, with aircraft 203 a relative distance behind and altitude above aircraft 201, and aircraft 205 a relative distance behind and altitude above aircraft 203.

FIG. 2 includes transmission indicators 210, 212, and 214. Transmission indicators 210, 212, and 214 represent pre-processed data transmissions from aircraft 201 to other aircraft within a transmission limit or a determined range from the current position of aircraft 201. The pre-processed data transmissions include sensor data generated and collected by aircraft 201, and aircraft performance data that includes operational parameters and specific aspects of aircraft 201 for the current flight. Receipt of transmission indicator 212 by aircraft 203 and transmission indicator 214 by aircraft 214 occurs during the flight of the respective aircraft in which both transmission indicators 212 and 214 represent a single transmission from aircraft 201 that includes the same transmitted data.

FIG. 2 depicts transmission indicator 210 as received by ground-based analysis model 220. Ground-based analysis model may receive transmission indicator 210 via air traffic control transmission receiving resources. In some embodiments, ground-based analysis model 220 analyzes weather sensor data and provides weather forecasting outputs, based on machine learning/artificial intelligence models that have been trained on a corpus of historic weather sensor data and corresponding conditions experienced. In some embodiments, the machine learning techniques include both supervised learning and unsupervised learning training sets, and artificial intelligence (AI) models may be artificial neural network (ANN) models having input and output node layers and may include one or more hidden layers. In some embodiments, ground-based analysis model 220 operates within a computing system, such as computer environment 100 (FIG. 1), and ground-based analysis model 220 provides updates to aircraft onboard models working in conjunction with methods of the present invention by performing post-processing of received pre-processed aircraft sensor data (i.e., weather-based data and encountered objects, such as a flock of birds and aircraft performance data).

An ANN includes a collection of connected units or nodes called artificial neurons, which loosely model the neurons in a biological brain. Each connection, like the synapses in a biological brain, can transmit a signal to other neurons. An artificial neuron receives signals then processes them and can signal neurons connected to it. Real numbers make up the “signal” at a neuron connection, and a non-linear function computes the output of each neuron from the sum of its inputs. The connections are called edges. Neurons and edges typically have a weight that adjusts as learning proceeds. The weight increases or decreases the strength of the signal at a connection. Neurons may have a threshold that sends a signal only if the aggregate signal crosses that threshold. Typically, neurons are aggregated into layers. Different layers may perform different transformations on their inputs. Signals travel from the first layer (i.e., the input layer), to the last layer (i.e., the output layer), possibly after traversing the layers multiple times.

In some embodiments the ANN processes input data to a first hidden layer, providing weighted values for functions of each node of the layer. Nodes of each subsequent layer receive weighted values and feed the resulting layer output to the next subsequent layer of the ANN. Determining the output of a node of the ANN includes generating a weighted sum of all the inputs of the node in which the respective weights are applied to the connections from the inputs to the respective nodes of the layer. The ANN processing adds a bias term to the sum, sometimes referred to as activation. The ANN produces an output of the node by passing the weighted sum through an activation function, often determined to be non-linear, to produce the output. The initial inputs are external data, such as sensor data in immediate embodiments, and the ultimate outputs achieve the result accomplished from training and continual learning from received data.

FIG. 2 includes transmission indicators 222, 224, and 226, which are transmissions from ground-based analysis model 220 that can include information on current weather conditions based on received aircraft-based data and include updates to onboard aircraft weather models that provide improved and more accurate output results, based on continuous learning of ground-based analysis model 220 from received aircraft in-flight transmissions. FIG. 2 depicts transmission indicator 222 as transmitted to aircraft 205, transmission indicator 224 as transmitted to aircraft 203, and transmission indicator 226 as transmitted to aircraft 201. It should be pointed out that transmission indicators 222, 224, and 226 are depicted indicators of a transmission event from ground-based analysis model 220 directed to aircraft within a determined region of aircraft 201, and transmission indicators 222, 224, and 226 are received by aircraft 201, 203, and 205 significantly later than receipt of transmission indicators 212 and 214, thus providing an improvement in detection and timing of potential mitigating action over ground-based weather condition alerts.

In some embodiments, the transmission of sensor data and performance data from respective aircraft includes use of a designated transmission frequency and may include a threshold of transmission power to limit transmission to the nearby region.

It should be pointed out that by receiving a transmission of pre-processed sensor and aircraft performance data from aircraft 201, in near-real time during the flight, the crew of aircraft 203 and 205 are pre-warned of potential adverse conditions and can take preemptive action to mitigate the adverse conditions for their respective aircraft. Methods of the present invention receive the pre-processed data and perform analysis and post-processing of the data to determine whether the data indicates an adverse condition, and based on the determined condition, methods provide options of recommendations to the respective crew of aircraft 203 and 205 to mitigate the adverse conditions. In some embodiments, the context of the received sensor data with respect to the attributes of the data-receiving aircraft may result in methods determining that no adverse condition exists for that particular aircraft. In some embodiments, the options or recommendations presented to the aircraft crew may be ranked from the highest recommendation to a lower recommendation level, based on the potential effectiveness of the recommendation for the specific adverse condition and the risks posed to the aircraft to perform the recommended action.

In an exemplary scenario, but not limiting, involving wind shear occurring on a landing approach of an aircraft, aircraft 201, 203, and 205 are aligned or becoming aligned into an approach landing glide pattern in preparation for landing at an airport. In the example, aircraft 201 leads in the landing approach, followed by aircraft 203, and then aircraft 205. The three aircraft are separated by a distance that provides for an aircraft landing every two to four minutes at the busiest airport times. Aircraft 201 approaches the landing on runway 29 when it begins experiencing wind shear conditions resulting in rapid changes of the aircraft airspeed in the order of an increase or decrease of 10-20 knots. Aircraft 201 loses lift as airspeed rapidly decreases, causing the aircraft to temporarily drop in altitude below the approved glide slope pattern until the pilots can react by taking actions to compensate for the unexpected conditions by increasing aircraft engine power.

Aircraft 201 sensor and aircraft performance data collection marks the zone of the wind shear conditions encountered (i.e., altitude, time, GPS position, direction) as a caution or risk zone, depending on the extent to which aircraft 201 was affected and how quickly and adequately aircraft 201 recovered. Aircraft 203, also on approach to land, designated as number 2 aircraft behind Aircraft 201 (i.e., number 1 for landing), follows the same glide slope as Aircraft 201 and may likely experience similar wind shear conditions.

Aircraft 201 atmospheric data and aircraft performance data are generated by sensors onboard aircraft 201, with some aircraft performance data generated and stored in onboard computer storage, such as aircraft type, weight, and cargo type. Methods of the present invention, operating on aircraft 201, collect the sensor and performance data and perform pre-processing of the collected raw data, generating a standardized machine-readable and consistently formatted set of data. Methods operating on aircraft 201 transmit the pre-processed data to aircraft within the transmission range of aircraft 201, which includes aircraft 203 and 205 in the example. Methods operating on aircraft 201 may include transmission of actions taken, such as increasing the engine power to a specified extent to recover the lost airspeed and return to the planned landing glide slope path. Methods send an automatic alert regarding the speed increase action taken by aircraft 201 to air traffic control, the conditions determined by aircraft 201, and the potential plans for aircraft 201 to land long on the runway.

Having received the transmitted pre-processed sensor and performance data from aircraft 201, methods of the present invention, operating on aircraft 203, process the received data and determine a wind shear condition may exist ahead on the landing approach path, and from the data received, methods determine a predicted affect the conditions will have based on the particular aspects of aircraft 203. Methods operating on aircraft 203 preemptively increase engine power, adding +10-20 knots to its approach speed to prevent dropping below the glide slope if the airspeed drops suddenly. Methods automatically alert Air traffic control regarding the actions taken by aircraft 203 and the potential for aircraft 203 to land long on the runway. Aircraft 205 similarly receives the transmitted data from aircraft 201, and also receives the transmitted data from aircraft 203 as it maneuvers through the landing glide slope on approach. Methods operating on aircraft 205 process the data received from aircraft 201 and 203 and analyze the data in the context of the particular aspects of aircraft 205, and methods determine whether the analysis of the received data in the context of aircraft 205 warrants a particular action (e.g., increasing engine power to add 10-20 knots of airspeed).

Having determined that the analysis of the received data, in context with the performance data of the respective aircraft indicates adverse conditions, methods operating on aircraft 201, 203, and 205 generate alerts identifying the adverse condition, which include at least one of an aural alert and a displayable alert. Generated alerts are presented to the crew of aircraft 201, 203, and 205. In some embodiments, the alerts are displayed using the flight management system (FMS) display features of the respective aircraft. In some embodiments, the displayed alert includes presentation of options of actions the crew can take to avoid or mitigate the adverse conditions. In some embodiments, the options are presented in a ranked order of effectiveness of avoiding or mitigating the adverse conditions, based on historic instances of encounters and actions taken of similar adverse conditions.

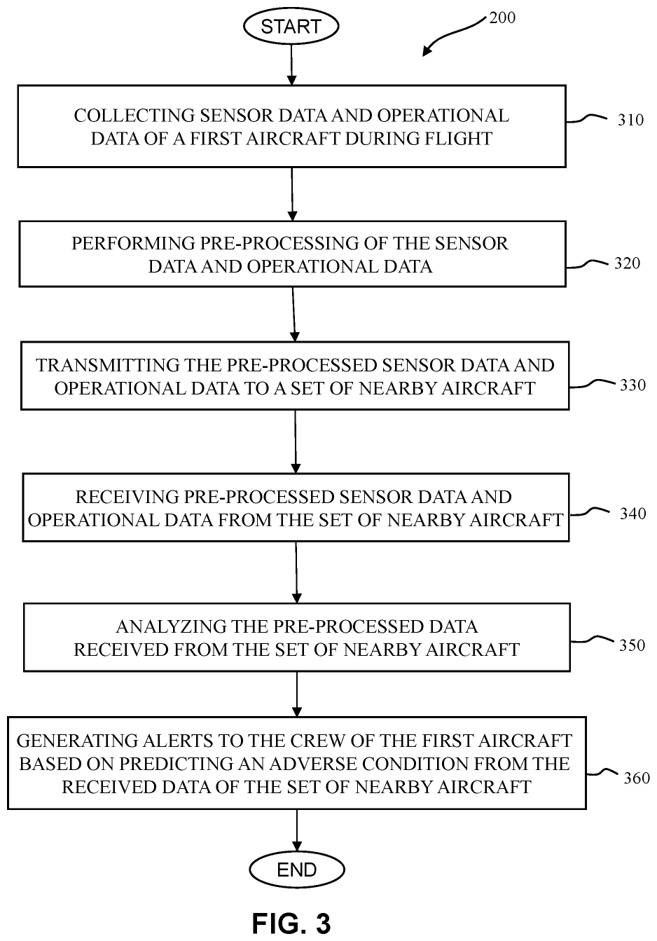

FIG. 3 provides a flowchart 300, illustrating exemplary activities associated with the practice of the disclosure. Subsequent to program initiation, at step 310, the method collects sensor data and operational data of a first aircraft during flight. Onboard sensors of a first aircraft generate data that includes weather-based data, such as, but not limited to, air pressure, wind speed, wind direction, humidity, precipitation, and temperature. In some embodiments, onboard sensors, such as radar or sonar, detect objects within or near the aircraft flight path, such as birds, other aircraft, drones, or other airborne objects. The method also collects aircraft operational data, such as the performance parameters of the aircraft, which may include, but not be limited to, values and rate of change of aircraft speed, direction, altitude, pitch, roll, yaw, and parameters of the aircraft, which can be included in computer storage aboard the aircraft indicating the aircraft type, cargo, weight, and other information that may be descriptive of the specific aircraft for the particular flight. The various types of information associated with the aircraft and with inflight performance parameters of the aircraft may be also referred to, herein, simply as “aircraft performance data”. The method collects the generated and accessed sensor and performance data.

At step 320, the method performs pre-processing of the sensor data and operational data. Pre-processing of raw sensor data includes standardizing values and value ranges, and units of measure into a consistent format that can be received and understood by computing devices operating machine learning or ANN models. Methods operating onboard a first aircraft during flight perform processing initial data analysis steps on the raw data received by sensors, radar or sonar aircraft flight parameter measurements, and aircraft information stored in onboard computer storage devices, accessible by methods of the present invention.

At step 330, the method, operating on the first aircraft, transmits the pre-processed aircraft sensor data and aircraft performance data to a set of nearby aircraft. Subsequent to performing pre-processing of the raw sensor and aircraft performance data, methods transmit the pre-processed data to other aircraft within a region of the first aircraft. The region may be determined by the transmission range limits of onboard systems used for transmissions, such as using ADSB or other aircraft-to-aircraft communication systems. All aircraft within the transmission region receive the pre-processed data from the first aircraft (i.e., weather sensor, object detection, and sending-aircraft performance data), which can be understood and processed further by the receiving aircraft within the transmission region.

At step 340, the method receives pre-processed sensor data and operational data from the set of nearby aircraft. In an embodiment of the present invention, the method operating on the first aircraft receives transmissions of sensor data and aircraft performance data from a set of other aircraft nearby or in the vicinity of the first aircraft, which are airborne and operating within a three-dimensional region that includes the first aircraft. In some embodiments, the local aircraft-to-aircraft transmission range during flight determines the three-dimensional region. In other embodiments, methods determine the “nearby” or “in the vicinity” aircraft in the three-dimensional region by a distance threshold as detected by onboard aircraft radar. The pre-processed data received from the set of nearby aircraft includes sensor data and aircraft performance data for the respective aircraft within the three-dimensional region.

At step 350, the method analyzes the pre-processed data received from the set of nearby aircraft. The method, in conjunction with onboard weather-based machine learning models, analyzes the received pre-processing data from the set of nearby aircraft, performs additional processing in conjunction with the weather-based model operating on the first aircraft, and outputs post-processed results. In some embodiments, methods produce the output in a form of a weather-based condition and may reflect favorable conditions or adverse conditions. The analysis performed includes the associated model processing the received pre-processed data from the set of nearby aircraft, which may be one or multiple aircraft. In some embodiments, the model operates as a component or module of the method, whereas in other embodiments, the model exists communicatively connected to the method and performs the analysis of the pre-processed data received from the set of nearby aircraft, based on provides a resulting output

At step 360, the method generates alerts to the crew of the first aircraft based on predicting an adverse condition from the received pre-processed data of the set of nearby aircraft. The method generates useful, aircraft context-based alerts that consider the analyzed pre-processed data generated from other aircraft in the vicinity that experience adverse conditions during flight. The method determines that the pre-processed data received from the set of nearby aircraft in the context of the first aircraft's attributes and performance data predicts a high probability that the first aircraft will encounter adverse conditions due to weather-related issues or obstruction issues (e.g., a flock of birds). The method identifies the type of adverse condition and generates an alert directed to the crew of the first aircraft. In some embodiments, the crew of the first aircraft receive communication of the alert via the flight management system (FMS) and viewed by crew members. The method communicates the alert by providing an aural alarm and displaying the identified adverse condition on a FMS display, viewable by the piloting crew.

In an embodiment, the method includes one or more options to avoid or mitigate the adverse condition and communicates the options to the aircraft crew. The options may be determined based on historical data of encountered adverse conditions and actions taken that avoided or mitigated the conditions. In some embodiments, the options are ranked and presented in a ranked order, which considers the attributes of the aircraft and the potential impact and/or risks of performing the particular option. For example, the ranking of options considers that an option may consume considerably more fuel, which may be a risk for aircraft low on fuel. The method communicates the post-processed information identifying the adverse condition and communicates the condition and the actions taken based on the ranked options to the ground-based analytical weather model, which incorporates the post-processed data and selected option along with the pre-processed data received from the set of other aircraft in the vicinity, for continual model learning and improvement.

Subsequent to completing the actions from the selected option, the method continues to collect the generated sensor data and performance data of the first aircraft and receive transmitted pre-processed data from nearby aircraft.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions collectively stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for local transmission of aircraft acquired data between airborne aircraft, the method comprising:
generating, by one or more processors of a first aircraft, sensor data and aircraft performance data during flight;
pre-processing, by the one or more processors of the first aircraft, the sensor data and performance data generating a context of the sensor data with respect to the first aircraft;
transmitting, by the one or more processors of the first aircraft, pre-processed sensor data and first aircraft performance data to a set of aircraft within a region of the first aircraft;
receiving, by the one or more processors of the first aircraft, pre-processed sensor data and aircraft performance data from aircraft of the set of aircraft within the region of the first aircraft;
processing, by the one or more processors of the first aircraft, the received pre-processed sensor data and performance data from the aircraft of the set of aircraft within the region of the first aircraft;
generating, by the one or more processors of the first aircraft, alerts associated with adverse conditions determined based on the analysis of the pre-processed sensor data and performance data received from the aircraft of the set of aircraft in the context of the aircraft performance data of the first aircraft; and
displaying, by the one or more processors of the first aircraft, the alerts associated with the adverse conditions in the context of the first aircraft including a description of the adverse conditions.

2. The method of claim 1, wherein the performance data during the flight include attributes of a respective aircraft of aircraft type, flight plan, GPS position, altitude, air speed, flight direction, aircraft weight, aircraft cargo, fuel level, subsystem status, and aircraft status within the flight plan.

3. The method of claim 1, wherein generating, by the one or more processors, the alerts associated with the adverse conditions includes generating options of actions to mitigate the adverse conditions and presenting the options to a crew of the first aircraft while displaying the alerts.

4. The method of claim 3, wherein generating the options of actions to mitigate the adverse conditions includes ranking the options in a recommended order based on risk associated with performing the option.

5. The method of claim 1, wherein a machine learning model onboard the first aircraft receives the pre-processed sensor data and performance data from the aircraft of the set of aircraft in the region and performs a post-processing analysis to determine a relevance of the received pre-processed sensor data and the aircraft performance data in the context of attributes and performance data of the first aircraft.

6. The method of claim 1, wherein the sensor data collected includes weather-based sensor data.

7. The method of claim 1, wherein the sensor data collected includes detection of objects within or approaching the flight path of the first aircraft.

8. The method of claim 7, wherein the detection of objects within or approaching a flight path of the first aircraft includes detection of one or more birds.

9. A computer program product for local transmission of aircraft acquired data between airborne aircraft, the computer program product comprising:
at least one computer-readable storage medium; and
program instructions stored on the at least one computer-readable storage medium, the program instructions comprising:
program instructions to generate sensor data and aircraft performance data during flight;
program instructions to pre-process the sensor data and performance data generating a context of the sensor data with respect to the first aircraft;
program instructions to transmit pre-processed sensor data and first aircraft performance data to a set of aircraft within a region of the first aircraft;
program instructions to receive pre-processed sensor data and aircraft performance data from aircraft of the set of aircraft within the region of the first aircraft;
program instructions to process the received pre-processed sensor data and performance data from the aircraft of the set of aircraft within the region of the first aircraft;
program instructions to generate alerts associated with adverse conditions determined based on the analysis of the pre-processed sensor data and performance data received from the aircraft of the set of aircraft in the context of the aircraft performance data of the first aircraft; and
program instructions to display the alerts associated with the adverse conditions in the context of the first aircraft and include a description of the adverse conditions.

10. The computer program product of claim 9, wherein the performance data during the flight include attributes of a respective aircraft of aircraft type, flight plan, GPS position, altitude, air speed, flight direction, aircraft weight, aircraft cargo, fuel level, subsystem status, and aircraft status within the flight plan.

11. The computer program product of claim 9, wherein program instructions to generate the alerts associated with the adverse conditions includes program instructions to generate options of actions to mitigate the adverse conditions and present the options to a crew of the first aircraft while displaying the alerts.

12. The computer program product of claim 11, wherein program instructions to generate the options of actions to mitigate the adverse conditions includes ranking the options in a recommended order based on risk associated with performing the option.

13. The computer program product of claim 9, further comprising:
program instructions to receive the pre-processed sensor data and performance data from the aircraft of the set of aircraft in the region, by a machine learning model onboard the first aircraft that performs a post-processing analysis to determine a relevance of the received pre-processed sensor data and the aircraft performance data in the context of attributes and performance data of the first aircraft.

14. The computer program product of claim 9, wherein the sensor data collected includes weather-based sensor data.

15. The computer program product of claim 9, wherein the sensor data collected includes detection of objects within or approaching the flight path of the first aircraft.

16. A computer system for local transmission of aircraft acquired data between airborne aircraft, the computer program product comprising:
one or more computer processors;
at least one computer-readable storage medium; and
program instructions stored on the at least one computer-readable storage medium, the program instructions comprising:
program instructions to generate sensor data and aircraft performance data during flight;
program instructions to pre-process the sensor data and performance data generating a context of the sensor data with respect to the first aircraft;
program instructions to transmit pre-processed sensor data and first aircraft performance data to a set of aircraft within a region of the first aircraft;
program instructions to receive pre-processed sensor data and aircraft performance data from aircraft of the set of aircraft within the region of the first aircraft;
program instructions to process the received pre-processed sensor data and performance data from the aircraft of the set of aircraft within the region of the first aircraft;
program instructions to generate alerts associated with adverse conditions determined based on the analysis of the pre-processed sensor data and performance data received from the aircraft of the set of aircraft in the context of the aircraft performance data of the first aircraft; and
displaying, by the one or more processors of the first aircraft, the alerts associated with the adverse conditions in the context of the first aircraft including a description of the adverse conditions.

17. The computer system of claim 16, wherein the performance data during the flight include attributes of a respective aircraft of aircraft type, flight plan, GPS position, altitude, air speed, flight direction, aircraft weight, aircraft cargo, fuel level, subsystem status, and aircraft status within the flight plan, and wherein program instructions to generate the alerts associated with the adverse conditions include program instructions to generate options of actions to mitigate the adverse conditions and communicating the options to a crew of the first aircraft.

18. The computer system of claim 16, wherein program instructions to generate options of actions to mitigate the adverse conditions and presenting the options to a crew of the first aircraft while displaying the alerts and wherein the program instructions include ranking the options in a recommended order based on risk associated with performing the option.

19. The computer system of claim 16, further comprising:
program instructions to receive the pre-processed sensor data and performance data from the aircraft of the set of aircraft in the region, by a machine learning model onboard the first aircraft that performs a post-processing analysis to determine a relevance of the received pre-processed sensor data and the aircraft performance data in the context of attributes and performance data of the first aircraft.

20. The computer program product of claim 9, wherein the sensor data collected includes detection of objects within or approaching the flight path of the first aircraft.
